(19) United States
(12) Patent Application Publication
(10) Pub. No.: US 2026/0034696 A1
(43) Pub. Date: Feb. 5, 2026

(54) CUTTING DEVICE, CUTTING METHOD, AND RECORDING MEDIUM

(71) Applicant: CASIO COMPUTER CO., LTD., Tokyo (JP)

(72) Inventor: Takao SEMBA, Tokyo (JP)

(73) Assignee: CASIO COMPUTER CO., LTD., Tokyo (JP)

(21) Appl. No.: 19/285,391

(22) Filed: Jul. 30, 2025

(30) Foreign Application Priority Data
Aug. 1, 2024 (JP) 2024-125533

(51) Int. Cl. B26D 5/00; B26D 1/06; B26D 5/02

(52) U.S. Cl. CPC B26D 5/005; B26D 1/06; B26D 5/02

(57) ABSTRACT

A cutting device includes: a cutter; a carriage that holds the cutter such that, when a relative position of the cutter with respect to a to-be-cut object is changed in a state in which a blade of the cutter bites into the held to-be-cut object, a direction of the blade is changed depending on a direction in which the relative position changes; an actuator that changes the relative position of the cutter held by the carriage with respect to the to-be-cut object in order to cut the to-be-cut object with the blade; and at least one processor that controls the actuator such that the blade of the cutter moves along a cutting line set on the to-be-cut object.

### CROSS-REFERENCE TO RELATED APPLICATION

The present application claims priority to Japanese Patent Application No. 2024-125533 filed on Aug. 1, 2024, the entire contents of which are incorporated herein.

### TECHNICAL FIELD

The present invention relates to a cutting device, a cutting method, and a recording medium.

### BACKGROUND

Some cutting devices that cut a sheet-like to-be-cut object (to-be-processed object) cut a desired shape from the to-be-cut object by relatively moving a cutter with respect to the to-be-cut object in a state where a blade of the cutter that cuts the to-be-cut object is brought into pressure contact with the to-be-cut object. In this type of cutting device, there is a cutting device in which a tip is offset with respect to a rotation axis that rotates the cutter such that the direction of the blade of the cutter can be changed, and the direction of the blade is automatically changed depending on the direction of the relative movement of the cutter with respect to a to-be-cut object (refer to JPA 1990-262995 and JPA 2014-008557, for example).

### SUMMARY

A cutting device according to an aspect of the present invention includes: a cutter; a carriage that holds the cutter such that, when a relative position of the cutter with respect to a to-be-cut object is changed in a state in which a blade of the cutter bites into the held to-be-cut object, a direction of the blade is changed depending on a direction in which the relative position changes; an actuator that changes the relative position of the cutter held by the carriage with respect to the to-be-cut object in order to cut the to-be-cut object with the blade; and at least one processor that controls the actuator such that the blade of the cutter moves along a cutting line set on the to-be-cut object, wherein when a cutting end position of a first cutting line set on the to-be-cut object and a cutting start position of a second cutting line to which the blade moved along the first cutting line is moved next are separated from each other, the at least one processor controls the actuator to perform cutting edge adjustment control of causing a direction of the blade facing a first direction at the cutting end position of the first cutting line to face a second direction for cutting the to-be-cut object from the cutting start position of the second cutting line.

### BRIEF DESCRIPTION OF THE DRAWINGS

FIG. 1A and FIG. 1B are diagrams illustrating a configuration example of a cutting device according to an embodiment;

FIG. 2 is a block diagram illustrating a functional configuration example of the cutting device;

FIG. 3A and FIG. 3B are diagrams illustrating a rotation operation of a cutter;

FIG. 4A to FIG. 4C are diagrams illustrating a first example of a to-be-cut object cutting procedure of the cutting device according to an embodiment;

FIG. 5 is a flowchart illustrating a first example of cutting processing performed by the cutting device according to an embodiment;

FIG. 6 is a diagram illustrating a first example of vector information for each cutting line;

FIG. 7 is a flowchart illustrating a second example of cutting processing performed by the cutting device according to an embodiment;

FIG. 8 is a diagram illustrating a second example of vector information for each cutting line;

FIG. 9A to FIG. 9C are diagrams illustrating a to-be-cut object cutting procedure in the second example of the cutting processing; and

FIG. 10 is a diagram illustrating an example of a curved cutting line set for a to-be-cut object.

### DETAILED DESCRIPTION

Hereinafter, embodiments of the present invention will be described with reference to the drawings. An X axis, a Y axis, and a Z axis in the drawings to be referred to are illustrated for the purpose of specifying a relationship between planes, directions, and the like of the same components illustrated in different drawings. The X axis, the Y axis, and the Z axis are orthogonal to each other and form a right-handed coordinate system. In the following description, a direction parallel to the X axis is referred to as an X direction, a direction parallel to the Y axis is referred to as a Y direction, and a direction parallel to the Z axis is referred to as a Z direction. In addition, in a case where each of the X direction, the Y direction, and the Z direction is associated with a direction of an arrow (positive or negative) of the X axis, the Y axis, and the Z axis illustrated in the figure, “+” or “−”, or “positive side” or “negative side” is added. For example, the “+X direction” and the “−X direction” mean the traveling direction of the arrow indicating the X axis and the direction opposite to the traveling direction. In addition, the “positive side in the X direction” refers to a side in the +X direction when viewed from a reference surface, member, position, and the like, and the “negative side in the X direction” refers to a side in the −X direction when viewed from a reference surface, member, position, and the like.

In the present specification, the Z direction may be referred to as a vertical direction. In the present specification, “upper” and “upward” are intended to be toward the positive side in the Z direction with respect to the reference surface, member, position, and the like, and “lower” and “downward” are intended to be toward the negative side in the Z direction with respect to the reference surface, member, position, and the like. For example, when it is described that “the member B is disposed on the member A”, the member B is disposed on the positive side in the Z direction as viewed from the member A. When the term “the upper surface of the member A” is used, the surface includes a surface that is located at an end of the member A on the positive side in the Z direction and faces the positive side in the Z direction. These directions and the names of the surfaces associated with the directions are merely used for convenience of description, and the correspondence relationship with the directions of the X axis, the Y axis, and the Z axis may change depending on the attachment posture of the exemplified cutting device and the like. For example, in the present specification, a surface referred to as an “upper surface” may be referred to as a “lower surface”, a “side surface”, or the like, and the designation of other surfaces may be changed accordingly.

In this specification and the drawings referred to in this specification, a plurality of the same components to which the same numeral is assigned are distinguished by a letter following the numeral. In the present specification, a plurality of the same components distinguished by letters after reference numerals may be distinguished by descriptions such as “first” and “second”. These descriptions are intended only to distinguish between a plurality of the same components, and a component prefaced with “first” herein may be referred to as a “second” component. Furthermore, in the present specification, when referring to matters common to a plurality of the same components, the notation of letters after the reference numerals and the description of “first (of)”, “second (of)”, and the like are omitted. For example, the first driving unit 7A, the second driving unit 7B, and the third driving unit 7C may be referred to as “driving unit 7”, “driving unit 7A, 7B, and 7C”, or the like.

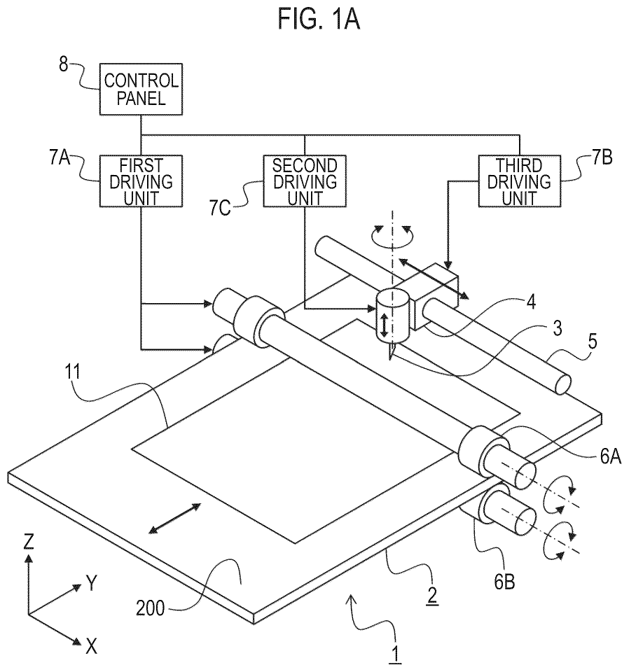

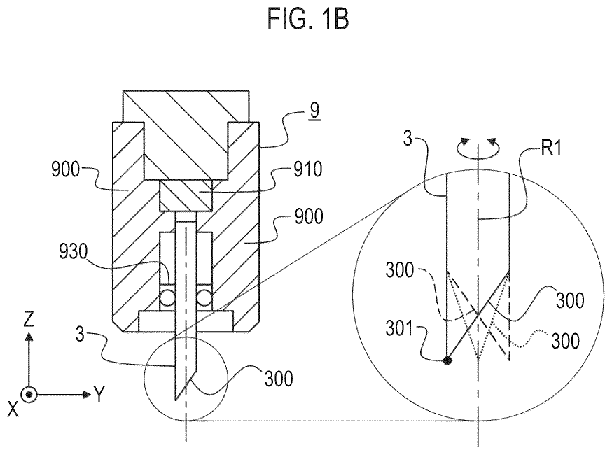

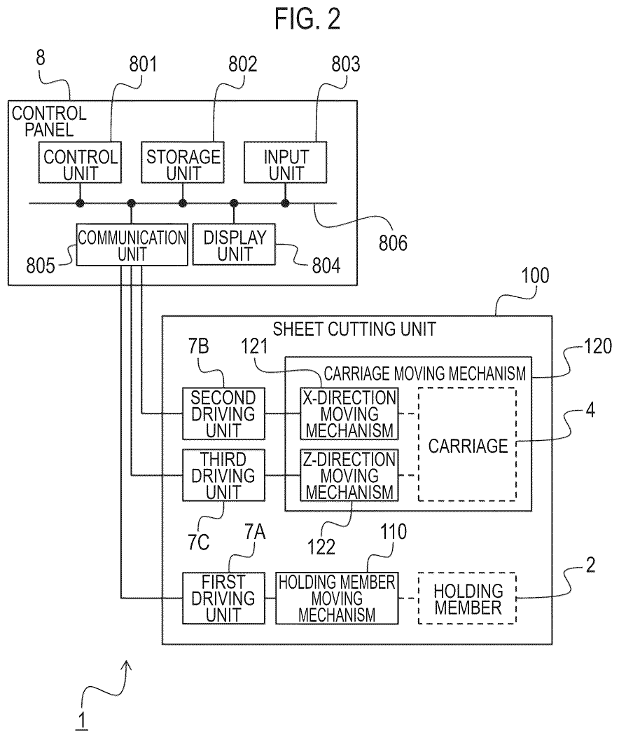

A cutting device 1 illustrated in FIG. 1A includes a holding member 2, a cutter 3, a carriage 4, a carriage support member 5, conveying rollers 6A and 6B, driving units 7A, 7B, and 7C, and a control panel 8. Note that FIG. 1A illustrates only main components related to the cutting operation for a to-be-cut object 11 among the components constituting the cutting device 1 according to an embodiment. From another point of view, as illustrated in FIG. 2, the cutting device 1 may include a sheet cutting unit 100 and the control panel 8 that controls the operation of the sheet cutting unit 100. The sheet cutting unit 100 includes driving units 7A, 7B, and 7C, a holding member moving mechanism 110, and a carriage moving mechanism 120, and the carriage moving mechanism 120 includes an X-direction moving mechanism 121 and a Z-direction moving mechanism 122. The above-described combination of components included in the sheet cutting unit 100 may be any combination of components of a known cutting device in which the direction of the blade is automatically changed according to the direction of the relative movement of a cutter 3 with respect to the to-be-cut object 11.

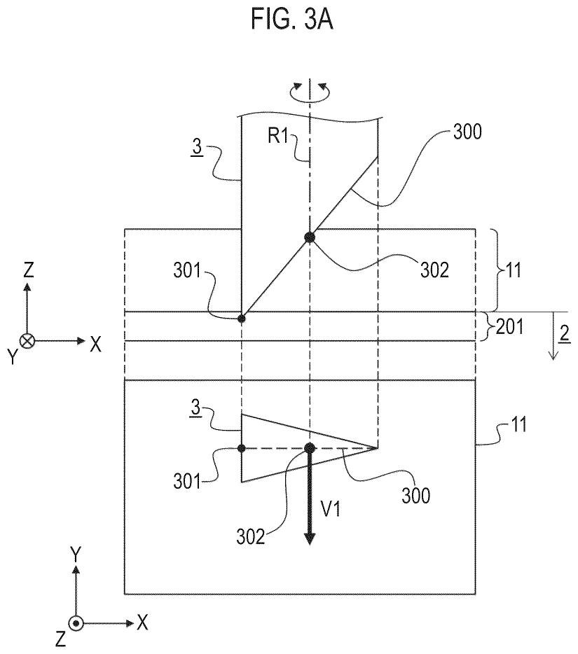

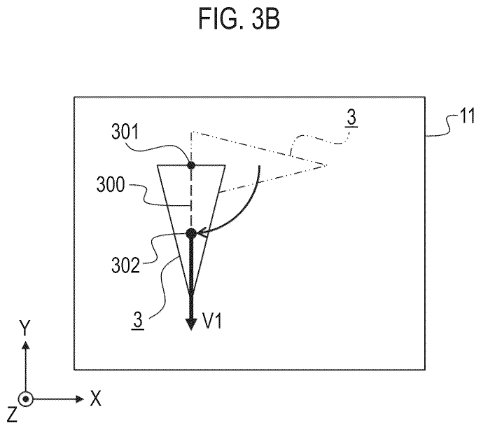

The holding member 2 is a member that holds a sheet-like to-be-cut object (to-be-processed object) 11, and includes a plate-shaped member 200 sometimes referred to as a mount, and an adhesive layer 210 disposed on an upper surface of the plate-shaped member 200 (refer to FIG. 3A). The adhesive layer 210 can be an example of a fixing member for preventing the position of the to-be-cut object 11 on the upper surface of the plate-shaped member 200 from being displaced. The plate-shaped member 200 of the holding member 2 has a portion to be clamped by the conveying rollers 6A and 6B outside a region where the to-be-cut object 11 is placed in a plan view (XY plan view) of the upper surface of the plate-shaped member 200. The plate-shaped member 200 illustrated in FIG. 1A has a clamped portion extending in the Y direction at each of an end portion on the positive side in the X direction and an end portion on the negative side in the X direction. The first conveying roller 6A comes into contact with the upper surface of the clamped portion of the plate-shaped member 200 and rotates about a rotation axis parallel to the X direction as a rotation fulcrum. The second conveying roller 6B comes into contact with the lower surface of the clamped portion of the plate-shaped member 200 and rotates about a rotation axis parallel to the X direction as a rotation fulcrum. The first conveying roller 6A and the second conveying roller 6B are included in the holding member moving mechanism 110 in the sheet cutting unit 100 illustrated in FIG. 2. The holding member moving mechanism 110 is a mechanism that moves the holding member 2 in the Y direction, and is configured such that the first conveying roller 6A and the second conveying roller 6B rotate in directions opposite to each other by the power of the first driving unit (for example, a stepping motor) 7A. One of the first conveying roller 6A and the second conveying roller 6B may be a main driving roller (driving roller) coupled to the first driving unit 7A, and the other roller may be a driven roller. The holding member moving mechanism 110 may be any of well-known mechanisms, and is not limited to a specific mechanism.

The cutter 3 is a cutting means that cuts the to-be-cut object 11 by changing a relative position of a blade (cutting edge) 300 (refer to FIG. 3A and FIG. 3B) that bites into the to-be-cut object 11 with respect to the to-be-cut object 11. The expression “bite into” in the present specification refers to applying a pressing force to the cutter 3 to bring the blade 300 of the cutter 3 into pressure contact with the to-be-cut object 11, and to pierce the blade 300 of the cutter 3 into the to-be-cut object 11. That is, “bite into”, “bit into”, and other similar expressions in the present specification are synonymous with “pressure contact” and “pressure contacted”, and other similar expressions, as well as “pierce”, “pierced”, and similar expressions. The cutter 3 may be a round bar made of a magnetic material such as steel or iron with the blade 300 formed at one end in the axial direction. The cutter 3 is attached to the carriage 4 so as to be able to change the direction of the blade 300 when cutting the to-be-cut object 11 based on cutting data. The “direction of the blade 300” in the present specification means a direction from the tip 301 of the blade (cutting edge) 300 toward the opposite end in the cross section of the cutter 3 (cross section parallel to the upper surface (XY plane) of the to-be-cut object 11 when cutting the to-be-cut object 11). For example, as illustrated in FIG. 1B, the cutter 3 is attached to a cutter holder 9 in such a manner that the cutter 3 itself can rotate such that the direction of the blade 300 can be changed by 360 degrees about the rotation axis R1 as the rotation center. The cutter 3 illustrated in FIG. 1B is attached to the cutter holder 9 in a state in which the tip 301 of the blade 300 is offset from the rotation axis R1.

The cutter holder 9 includes a cylindrical portion 900, a magnet 910, a cap 920, and a bearing 930. The cylindrical portion 900 has an upper accommodating portion that accommodates the magnet 910 and a lower accommodating portion that accommodates the bearing 930 that rotatably supports the cutter 3, and is a substantially cylindrical member in which the upper accommodating portion and the lower accommodating portion communicate with each other by a small-diameter hole. The position of the magnet 910 accommodated in the upper accommodating portion is fixed by fitting the cap 920 into the upper accommodating portion. As described above, the cutter 3 may be a round bar made of a magnetic material such as steel or iron in which the blade 300 is formed at one end in the axial direction. An end (upper end portion) of the cutter 3 opposite to the end where the blade 300 is formed is rotatably inserted into the small-diameter hole of the cylindrical portion 900, and an intermediate portion between the upper end portion and the end (lower end portion) where the blade 300 is provided is rotatably supported by the bearing 930. The cutter holder 9 is attached to the carriage 4 such that the rotation axis R1, which is a rotation center of the cutter 3, is parallel to the Z axis when the to-be-cut object 11 is cut.

The carriage 4 is supported by the carriage support member 5 so as to be able to move the cutter 3 in the X direction. The carriage support member 5 in the cutting device 1 illustrated in FIG. 1A is a round bar and is disposed such that the axis extends in the X direction. The carriage 4 of the cutting device 1 illustrated in FIG. 1A is supported by the carriage support member 5 so as to be rotatable about an axis (X axis) of the carriage support member 5 as a rotation fulcrum. That is, the cutter 3 in the illustrated cutting device 1 can be turned about the axis (X axis) of the carriage support member 5 as a rotation fulcrum, and can be moved to a position at which the to-be-cut object 11 is cut (a position at which the cutter 3 bites into the to-be-cut object 11) and a position at which the cutter 3 is separated from the to-be-cut object 11.

The carriage 4 is coupled to the X-direction moving mechanism 121 and the Z-direction moving mechanism 122 of the carriage moving mechanism 120 illustrated in FIG. 2. The X-direction moving mechanism 121 is configured such that the carriage 4 moves in the X direction by the power of the second driving unit (for example, a stepping motor) 7B. The Z-direction moving mechanism 122 is configured such that the blade 300 of the cutter 3 moves in the Z direction by the power of the third driving unit (for example, a stepping motor) 7C. As described above, the carriage 4 in the cutting device 1 illustrated in FIG. 1A can be rotated with the axis of the carriage support member 5 as a rotation fulcrum. The Z-direction moving mechanism 122 in the cutting device 1 of this type can be configured to rotate the carriage 4 about the axis of the carriage support member 5 as a fulcrum. By rotating the carriage 4, the cutter 3 turns about the axis of the carriage support member 5 as a rotation fulcrum, and the position of the blade 300 of the cutter 3 in the Z direction is changed. The X-direction moving mechanism 121 and the Z-direction moving mechanism 122 may be any of well-known mechanisms, and are not limited to a specific mechanism. For example, the Z-direction moving mechanism 122 may be a mechanism that translates a part or all of the carriage 4 in the Z direction such that the blade 300 of the cutter 3 moves in the Z direction (that is, parallel to the Z direction).

The first driving unit 7A and the holding member moving mechanism 110, and the second driving unit 7B and the X-direction moving mechanism 121 in the cutting device 1 described above are an example of an actuator that changes the relative position of the blade 300 of the cutter 3 with respect to the to-be-cut object 11 held by the holding member 2 in a plan view of the upper surface (XY plane) of the to-be-cut object 11. The actuator in the cutting device 1 may have a configuration in which a mechanism capable of moving the carriage 4 in the Y direction is added to the carriage moving mechanism 120 instead of the holding member moving mechanism 110, for example. As a specific example, the cutting device 1 may be configured such that the carriage support member 5 is movable in the Y direction by the first driving unit 7A, and the conveying rollers 6A and 6B may be omitted. The actuator in the cutting device 1 may include, for example, a mechanism that rotates the holding member 2 (to-be-cut object 11) in a plane parallel to the upper surface of the plate-shaped member 200. The third driving unit 7C and the Z-direction moving mechanism 122 in the cutting device 1 described above are an example of an actuator that changes the relative position of the blade 300 of the cutter 3 with respect to the to-be-cut object 11 in the thickness direction (Z direction) of the to-be-cut object 11. That is, the term “actuator” in the present specification intends a means capable of both changing the relative position of the blade 300 of the cutter 3 with respect to the to-be-cut object 11 in the XY plane parallel to the upper surface of the to-be-cut object 11 and changing the relative position of the blade 300 of the cutter 3 with respect to the to-be-cut object 11 in the thickness direction (Z direction) of the to-be-cut object 11.

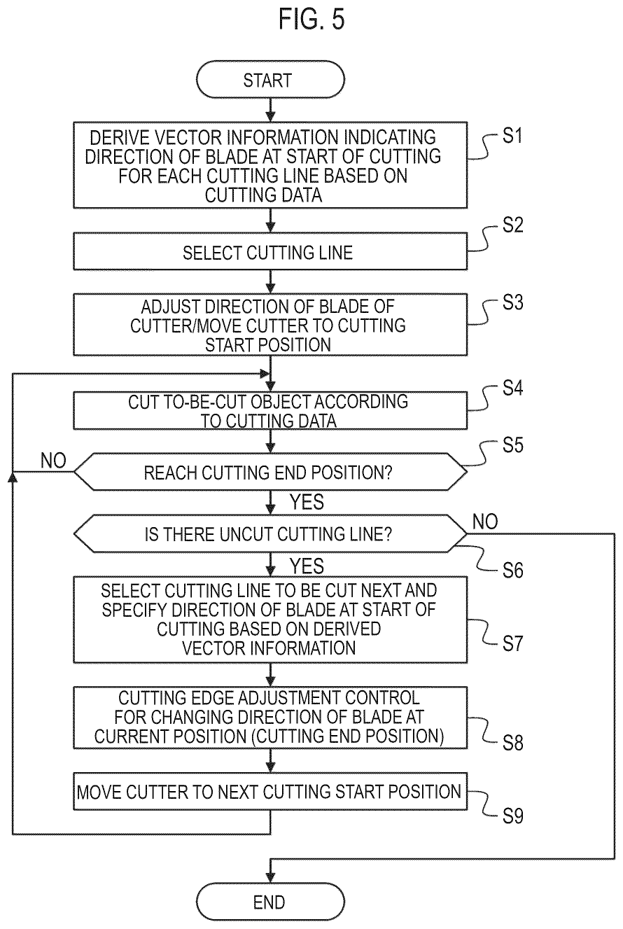

The operation of the cutting device 1 is controlled by the control panel 8. As illustrated in FIG. 2, the control panel 8 includes a control unit 801, a storage unit 802, an input unit 803, a display unit 804, and a communication unit 805, and these components are connected to each other by a bus 806. The control unit 801 controls the operation of the sheet cutting unit 100 by executing a control program including processing which will be described later with reference to FIG. 5. The function of the control unit 801 is provided by a processor such as a central processing unit (CPU) that executes a control program stored in the storage unit 802. The storage unit 802 is a recording medium that stores a control program for controlling the operation of the sheet cutting unit 100, cutting data including information regarding a cutting line (cutting path) set on the to-be-cut object 11, and the like. The functions of the storage unit 802 can be provided by a read only memory (ROM) and a random access memory (RAM) as main storage devices. The storage devices that provide the functions of the storage unit 802 may include an auxiliary storage device such as a hard disk drive (HDD) or a solid state drive (SSD). The input unit 803 receives an operation for inputting and selecting a control parameter related to the operation of the sheet cutting unit 100. The display unit 804 visualizes and displays a control parameter related to the operation of the sheet cutting unit 100 and information indicating an operation state. The functions of the input unit 803 and the display unit 804 are provided by, for example, an operation panel in which an input device such as a switch or a keyboard and a display device such as a liquid crystal display are integrated. The operation panel may have a touch panel display having a function as the input unit 803 and a function as the display unit 804. The communication unit 805 performs communication with the sheet cutting unit 100 in a wired or wireless manner, acquisition of an operation state of the sheet cutting unit 100, transmission of a control signal to the sheet cutting unit 100, and the like. For example, the communication unit 805 can communicate with an imaging device (not illustrated) that captures an image indicating a cutting line set on the to-be-cut object 11, and may acquire data of the image captured by the imaging device as cutting data or original data thereof. When data of an image captured by the imaging device is acquired as original data of cutting data, the control unit 801 performs processing of deriving a cutting line from the original data (image).

Note that the control panel 8 is not limited to one designed and manufactured as a device dedicated to controlling the sheet cutting unit 100, and may be one that causes a general-purpose computer such as a personal computer to execute a computer-readable control program. A plurality of functions illustrated by being divided into a plurality of blocks in the control panel 8 of FIG. 2 may be provided by one piece of hardware. For example, the function of the control unit 801 and the function of the storage unit 802 may be provided by an integrated circuit device such as a field programmable gate array (FPGA) or an application specific integrated circuit (ASIC). In addition, the function indicated by one block in the control panel 8 of FIG. 2 may be provided by a plurality of separate pieces of hardware. For example, the function of the storage unit 802 can be provided by a ROM, a RAM, an auxiliary storage device such as an HDD, and the like as described above. Furthermore, the number of processors that provide the function of the control unit 801 may be 2 or more.

As described above with reference to FIG. 1B, the cutting device 1 of the present embodiment can change the direction of the blade (cutting edge) 300 of the cutter 3 by 360 degrees about the rotation axis R1 as the rotation center, and the tip 301 is offset from the rotation axis R1. At the start of cutting of the to-be-cut object 11 by the blade 300 of the cutter 3, the direction of the blade (cutting edge) 300 of the cutter 3 biting into the to-be-cut object 11 may be the +X direction, as illustrated in FIG. 3A. At this time, when the operation of the cutting device 1 (sheet cutting unit 100) is controlled such that the relative position of the cutter 3 with respect to the to-be-cut object 11 changes in the +X direction, the cutter 3 can cut the to-be-cut object 11 in a state in which the direction of the blade 300 is maintained as the +X direction.

Furthermore, in the cutting device 1 of the present embodiment, for example, when the direction of the blade (cutting edge) 300 of the cutter 3 bitten into the to-be-cut object 11 is the +X direction, the operation can be controlled such that the relative position of the cutter 3 with respect to the to-be-cut object 11 changes in the −Y direction. At this time, when the tip 301 of the blade 300 is offset from the rotation axis R1 as the rotation center of the cutter 3, the cutter 3 that has received the force in the −Y direction (vector V1) rotates about the tip 301 as a fulcrum, and the direction of the blade 300 becomes the −Y direction as illustrated in FIG. 3B. Therefore, when the operation is continued such that the relative position of the cutter 3 with respect to the to-be-cut object 11 changes in the −Y direction, the to-be-cut object 11 can be cut in the −Y direction by the cutter 3 in which the direction of the blade 300 is changed in the −Y direction. However, when the direction of the blade 300 of the cutter 3 biting into the to-be-cut object 11 is changed from the +X direction (FIG. 3A) to the −Y direction (FIG. 3B), the entire portion of the blade 300 biting into the to-be-cut object 11 rotates about the tip 301 as a fulcrum. At this time, the cutter 3 changes the relative position with respect to the to-be-cut object 11 such that the rotation axis R1 passing through the blade center 302 (refer to FIG. 3A) turns about the tip 301 as a fulcrum in plan view. That is, when the direction of the blade 300 of the cutter 3 biting into the cutting start position is different from the cutting direction, after a cut is made in a direction different from the cutting direction from the position of the tip 301 that can be the cutting start position in plan view, the direction of the blade 300 is changed in a state in which pressing force in the cutting direction is applied from the cutter 3 to the to-be-cut object 11. For this reason, when the direction of the blade 300 of the cutter 3 biting into the cutting start position is different from the cutting direction, the direction of the blade 300 is changed at the start of cutting and the blade 300 is pressed so as to bite into the to-be-cut object 11, and thus the to-be-cut object 11 is more likely to be scratched than when the direction of the blade 300 is changed during cutting. For example, in a case where a first cutting line and a second cutting line set on the to-be-cut object 11 are separated from each other, and the direction of the blade 300 of the cutter 3 at the end of cutting of the first cutting line is different from the direction of the blade 300 at the start of cutting of the second cutting line, when the cutter 3 is moved to the cutting start position of the second cutting line in the direction of the blade 300 at the end of cutting of the first cutting line and cutting of the second cutting line is started, the cutting start position of the second cutting line is likely to be scratched.

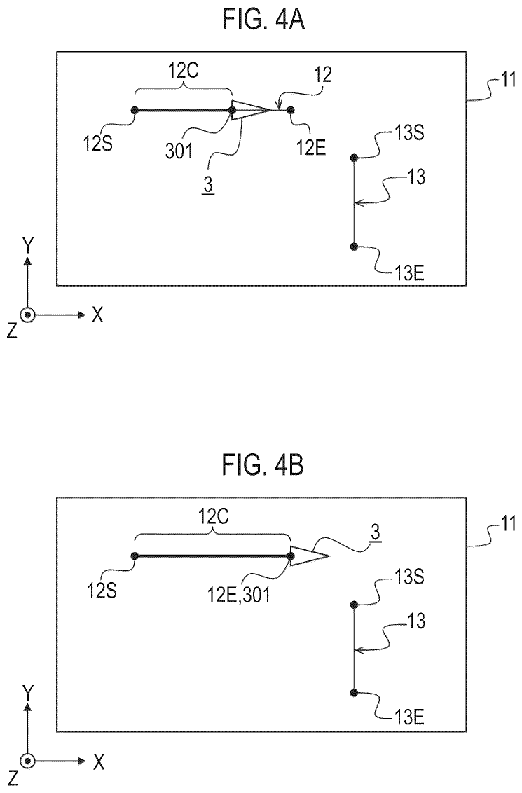

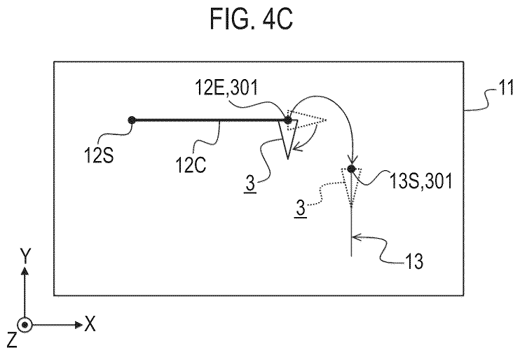

In view of such a problem, in the cutting device 1 of the present embodiment, cutting along the first cutting line and cutting along the second cutting line set on the to-be-cut object 11 are performed by a procedure illustrated in FIG. 4A to FIG. 4C. The first cutting line 12 represented by a straight line extending in the X direction and the second cutting line 13 represented by a straight line extending in the Y direction are set on the to-be-cut object 11 illustrated in FIG. 4A. The direction of the blade 300 is the +X direction, and the cutter 3 cuts the to-be-cut object 11 from a cutting start position 12S at the left end of the first cutting line 12 toward a cutting end position 12E at the right end. That is, in the to-be-cut object 11 illustrated in FIG. 4A, a section 12C indicated by a thick line from the cutting start position 12S to the tip 301 of the blade of the cutter 3 is cut.

FIG. 4B illustrates the to-be-cut object 11 and the cutter 3 when the tip 301 of the cutter 3 reaches the cutting end position 12E of the first cutting line 12, that is, when cutting along the first cutting line 12 is completed. Thereafter, the cutting device 1 subsequently performs cutting along the second cutting line 13. Since a cutting start position 13S of the second cutting line 13 is separated from the cutting end position 12E of the first cutting line 12, the cutting device 1 changes the relative position of the cutter 3 with respect to the to-be-cut object 11 such that the tip 301 moves to the cutting start position 13S of the second cutting line 13 after separating the blade 300 of the cutter 3 from the to-be-cut object 11. Note that the second cutting line 13 illustrated in FIG. 4B extends in the Y direction, and the direction of the blade 300 of the cutter 3 is the −Y direction when the to-be-cut object 11 is cut along the second cutting line 13. That is, when the cutter 3 is moved to the cutting start position 13S of the second cutting line 13 without changing the direction of the blade 300, the direction of the blade 300 of the cutter 3 is changed at the cutting start position 13S (refer to FIG. 3A and FIG. 3B), and a scratch may be generated at the cutting start position 13S of the second cutting line 13 on the to-be-cut object 11. Therefore, in the cutting device 1 of the present embodiment, after the tip 301 of the cutter 3 reaches the cutting end position 12E of the first cutting line 12, as illustrated in FIG. 4C, before the blade of the cutter 3 is separated from the to-be-cut object 11, the direction of the blade 300 of the cutter 3 is changed to the −Y direction at the cutting end position 12E of the first cutting line 12. At this time, for example, the control unit 801 of the control panel 8 drives the first driving unit 7A and the second driving unit 7B to move the cutter 3 in the −Y direction from the cutting end position 12E of the first cutting line 12 by the same distance as the offset value of the tip 301 with respect to the rotation axis R1 of the cutter 3. As a result, the direction of the blade 300 of the cutter 3 can be changed to the −Y direction while suppressing the progress of cutting in the −Y direction from the cutting end position 12E of the first cutting line 12. After the direction of the blade 300 is changed, the relative position of the cutter 3 with respect to the to-be-cut object 11 is changed such that the tip 301 moves to the cutting start position 13S of the second cutting line 13. As a result, it is possible to prevent the to-be-cut object 11 from being scratched due to change in the direction of the blade 300 of the cutter 3 at the start of cutting of the second cutting line 13. Further, as a result, the to-be-cut object 11 is scratched at the cutting end position 12E of the first cutting line 12, but since this scratch is caused by change in the direction of the blade 300 of the cutter 3 during cutting of the first cutting line 12, the scratch is less than scratch on the to-be-cut object 11 caused by change in the direction of the blade 300 of the cutter 3 while causing the tip 301 to bite at the start of cutting of the second cutting line 13. The operation for changing the direction of the blade 300 of the cutter 3 at the cutting end position 12E is not limited to a specific operation under specific conditions. For example, the changed direction of the blade 300 of the cutter 3 may not match the cutting direction at the start of cutting of the next cutting line. By changing the direction of the blade 300 of the cutter 3 at the cutting end position such that the difference from the cutting direction at the start of cutting of the next cutting line is reduced, the rotation angle of the blade 300 of the cutter 3 at the start of cutting of the next cutting line can be reduced, and scratch generated at the cutting start position can be reduced.

Further, when the direction of the blade 300 of the cutter 3 is changed from the +X direction to the −Y direction at the cutting end position 12E of the first cutting line 12, there is the section 12C where the to-be-cut object 11 is cut on the negative side in the X direction with respect to the tip 301. For this reason, when the blade 300 of the cutter 3 rotates with the tip 301 as a fulcrum, a portion of the to-be-cut object 11 that is in contact with the side surface of the blade 300 is more likely to be flexibly deformed compared to a case where there is no cut section 12C (the case illustrated in FIG. 3A and FIG. 3B), and a scratch generated on the to-be-cut object 11 is less likely to be conspicuous. Furthermore, since the direction of the blade 300 is changed at the cutting end position 12E of the first cutting line 12, the operation of moving the cutter 3 to the outside of the region of the holding member 2 where the to-be-cut object 11 is disposed can be omitted. Therefore, the movement distance when the cutter 3 is moved from the cutting end position 12E to the cutting start position 13S of the second cutting line 13 can be set to the shortest distance, and cutting can be efficiently performed.

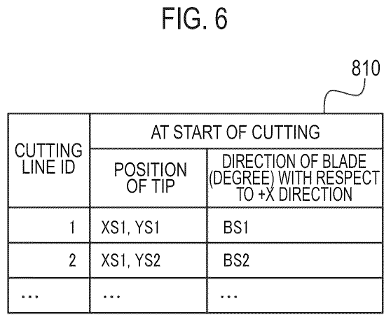

The cutting device 1 of the present embodiment can perform, for example, processing according to the flow of FIG. 5 in order to cut the to-be-cut object 11 through the procedure illustrated in FIG. 4A to FIG. 4C. Processing according to the flow of FIG. 5 is mainly performed by the control unit 801 of the control panel 8 in the cutting device 1. First, the control unit 801 derives vector information 810 indicating the direction of the blade 300 at the start of cutting for each cutting line based on cutting data (step S1). One cutting line may be one line connecting a cutting start position and a cutting end position along which cutting can be advanced without separating the blade 300 of the cutter 3 from the to-be-cut object 11. Information on one cutting line in cutting data includes information indicating the direction of change in the relative position of the cutter 3 with respect to the to-be-cut object 11 at several points on the cutting path from the cutting start position to the cutting end position. One cutting line is not limited to straight cutting lines such as the first cutting line 12 and the second cutting line 13 illustrated in FIG. 4A. For example, as illustrated in FIG. 6, the vector information 810 includes information indicating the position of the tip 301 and the direction of the blade 300 at the start of cutting in each cutting line. The direction of the blade 300 may be a direction of change in the relative position of the cutter 3 with respect to the to-be-cut object 11 at the start of cutting. In the vector information 810 of FIG. 6, the information indicating the direction of the blade 300 is an angle of the blade direction with respect to the +X direction. This angle is derived, for example, with the X direction in plan view of the upper surface of the to-be-cut object 11 illustrated in FIG. 4A and the like as a starting line, the counterclockwise direction as a positive angle, and the clockwise direction as a negative angle. The information indicating the direction of the blade 300 in the vector information 810 is not limited to the above-described angle, and may be a component of a vector or the like corresponding to the direction of the relative movement of the cutter 3 with respect to the to-be-cut object 11.

After deriving the vector information 810, the cutting device 1 selects a cutting line (step S2), and adjusts the direction of the blade 300 of the cutter 3 and moves the cutter 3 to the cutting start position (step S3). In step S3, in order to adjust the direction of the blade 300 of the cutter 3, the control unit 801 of the control panel 8 refers to, for example, the vector information 810, and controls the operation of the sheet cutting unit 100 on the basis of the information on the direction of the blade 300 at the start of cutting of the selected cutting line. As an example, the control unit 801 performs control to bring the blade 300 of the cutter 3 into pressure contact with an adjustment region provided on the outer side or the like of the region where the to-be-cut object 11 is placed in the plate-shaped member 200 of the holding member 2, and then controls the moving direction and the movement amount of the holding member moving mechanism 110 and the moving direction and the movement amount of the X-direction moving mechanism 121 based on the information on the direction of the blade 300. The moving direction and the movement amount of the holding member moving mechanism 110 are controlled by the first driving unit 7A, and the moving direction and the movement amount of the X-direction moving mechanism 121 are controlled by the second driving unit 7B. After adjusting the direction of the blade 300, the control unit 801 controls the operation of the sheet cutting unit 100 according to a known control method such that the tip 301 of the blade 300 of the cutter 3 bites (pierces) into the cutting start position set on the to-be-cut object 11 based on the cutting data.

After step S3, the cutting device 1 cuts the to-be-cut object 11 according to the cutting data (step S4). In step S4, the control unit 801 of the control panel 8 controls the operation of the sheet cutting unit 100 according to a known control method. The control unit 801 continues processing of step S4 until the tip 301 of the cutter 3 reaches the cutting end position (step S5; NO). When the tip 301 of the cutter 3 reaches the cutting end position (step S5; YES), the control unit 801 determines whether there is an uncut cutting line with reference to, for example, the vector information 810 (step S6). When it is determined that there is no uncut cutting line (step S6; NO), the cutting device 1 ends cutting processing on the to-be-cut object 11 held by the holding member 2 at the time of determination.

When it is determined that there is an uncut cutting line (step S6; YES), the control unit 801 selects a cutting line to be cut next, and specifies the direction of the blade 300 at the start of cutting on the basis of the vector information 810 derived in step S1 (step S7). Subsequently, the control unit 801 performs cutting edge adjustment control for controlling the direction of the blade 300 at the current relative position (cutting end position) of the cutter 3 with respect to the to-be-cut object 11 (step S8). In step S8, the control unit 801 controls the relative position of the cutter 3 with respect to the to-be-cut object 11 such that the direction of the blade 300 of the cutter 3 becomes the direction of the blade 300 specified in step S7. After the cutting edge adjustment control of step S8, the control unit 801 of the cutting device 1 moves the cutter 3 to the next cutting start position (step S9), and performs processing of step S4 and subsequent steps. In step S8, the control unit 801 of the control panel 8 performs control to move the relative position of the blade 300 with respect to the to-be-cut object 11 by a predetermined movement amount in a direction corresponding to the direction of the blade 300 specified in step S7 while the blade 300 is biting into the to-be-cut object 11. In step S9, the control unit 801 controls the operation of the sheet cutting unit 100 according to a known control method.

When the cutting device 1 performs cutting processing according to the flowchart illustrated in FIG. 5, the control unit 801 of the control panel 8 derives the vector information 810 about the first cutting line 12 and the second cutting line 13 illustrated in FIG. 4A in step S1. When the first cutting line 12 is selected in step S2 to cut the to-be-cut object 11, the control unit 801 selects the second cutting line 13 as the next cutting line in step S7 and specifies the direction of the blade 300 at the start of cutting based on the vector information 810. Thereafter, as illustrated in FIG. 4C, the operation of the sheet cutting unit 100 is controlled such that the direction of the blade 300 is changed to the −Y direction at the cutting end position 12E of the first cutting line 12 (step S8). At this time, since the to-be-cut object 11 that receives the external force from the blade 300 according to rotation of the cutter 3 is in a state of being cut from the cutting start position 12S to the cutting end position 12E, the to-be-cut object 11 is less likely to be scratched as described above. Furthermore, the control unit 801 controls the operation of the sheet cutting unit 100 such that the tip 301 of the cutter 3 whose direction of the blade 300 has been changed to the −Y direction is moved from the cutting end position 12E of the first cutting line 12 to the cutting start position 13S of the second cutting line 13 (step S9). Therefore, in the cutting device 1 of the present embodiment, it is possible to prevent the occurrence of scratch in the portion of the cutting start position of the to-be-cut object 11 at the start of cutting of the to-be-cut object 11 along the second cutting line 13. Furthermore, the operation of moving the cutter 3 to the outside of the region where the to-be-cut object 11 is placed in the holding member 2 to change the direction of the blade 300 can be omitted, and the time required to cut the to-be-cut object 11 can be prevented from increasing, and thus cutting processing can be efficiently performed.

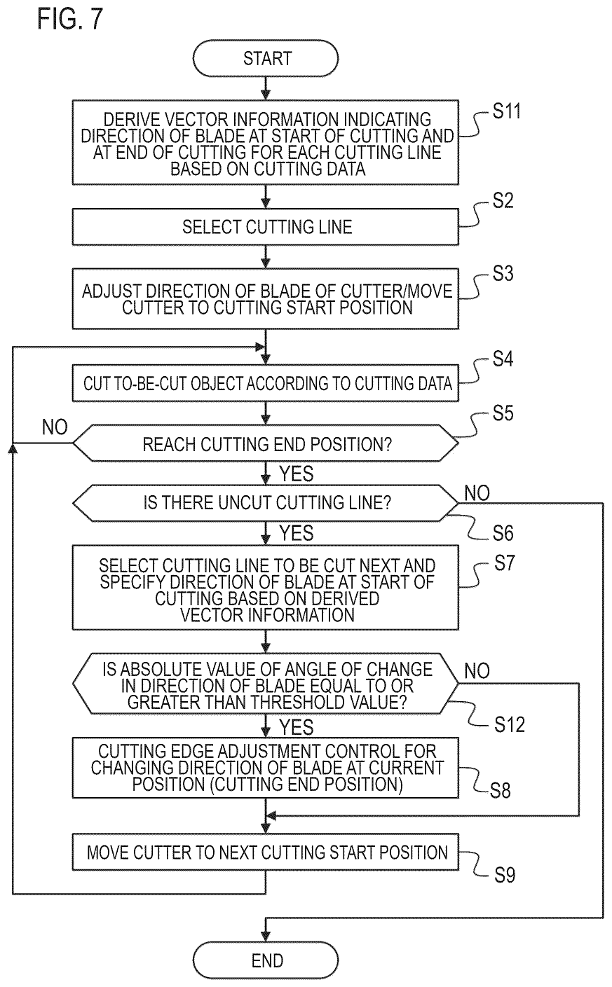

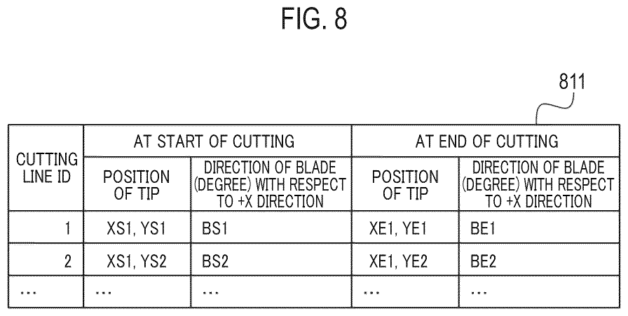

Note that the processing described above with reference to FIG. 5 and FIG. 6 is merely an example of cutting processing performed by the cutting device 1 according to an embodiment on the basis of cutting data. The cutting processing performed by the cutting device 1 may be, for example, processing according to the flow of FIG. 7. In the following description, the processing according to the flow of FIG. 5 is referred to as a “first example of cutting processing”, and the processing according to the flow of FIG. 7 is referred to as a “second example of cutting processing”. In the second example of cutting processing, when the absolute value of an angle of change from the direction of the blade 300 at the cutting end position 12E of the first cutting line 12 to the direction of the blade 300 at the cutting start time of the second cutting line 13 to be cut next is equal to or greater than a threshold value, the direction of the blade 300 is changed at the cutting end position 12E of the first cutting line 12. Therefore, in the second example of cutting processing, first, vector information 811 indicating the directions of the blades 300 at the start and end of cutting is derived for each cutting line based on the cutting data (step S11). For example, as illustrated in FIG. 8, the vector information 811 derived in step S11 may be given such that each of the direction of the blade 300 at the start of cutting and the direction of the blade 300 at the end of cutting in each cutting line is given at an angle with respect to the +X direction. In the second example of cutting processing, after step S11, processing similar to steps S2 to S7 described above in the first example of cutting processing is performed. After the direction of the blade 300 at the start of cutting of the cutting line to be cut next is specified in step S7, the control unit 801 of the cutting device 1 determines whether the absolute value of the angle of change from the current direction of the blade 300 to the direction of the blade 300 at the start of cutting of the cutting line to be cut next is equal to or greater than the threshold value (step S12). The threshold value for the absolute value of the angle of change may be, for example, 30 degrees. When the angle of change is equal to or greater than the threshold value (step S12; YES), the cutting device 1 performs cutting edge adjustment control of controlling the direction of the blade 300 at the current relative position (cutting end position) of the cutter 3 with respect to the to-be-cut object 11 (step S8), and when the angle of change is less than the threshold value (step S12; NO), omits the cutting edge adjustment control in step S8. That is, in the second example of cutting processing, when the absolute value of the difference in angle between the direction of the blade 300 at the end of cutting of a certain cutting line and the direction of the blade 300 at the start of cutting of the cutting line to be cut next is less than the threshold value, the direction of the blade 300 is changed at the start of cutting of the cutting line to be cut next.

The cutting device 1 of the present embodiment can set a cutting line that is oblique to both the X direction and the Y direction, such as a third cutting line 17 shown in FIG. 7A, on the to-be-cut object 11. The first cutting line 12 set on the to-be-cut object 11 illustrated in FIG. 7A extends in the X direction, and a vector VE corresponding to the direction of the blade 300 at the cutting end position 12E is the +X direction. On the other hand, the third cutting line 17 is inclined by an angle AB (for example, 25 degrees) with respect to the +X direction, and a vector VS corresponding to the direction of the blade 300 at a cutting start position 17S is a direction rotated by an angle AB from the +X direction. When the angle AB, which is the angle of change of the direction of the blade 300, is 25 degrees and the threshold value in the determination of step S12 is 30 degrees, the control unit 801 determines in step S12 that “the absolute value of the angle of change is not equal to or greater than the threshold value (NO)”. Therefore, the control unit 801 omits processing of controlling the direction of the blade 300 of the cutter 3 at the cutting end position 12E (step S8), and moves the cutter 3 to the cutting start position 17S of the third cutting line 17 while keeping the direction of the blade 300 in the +X direction as illustrated in FIG. 7B. Thereafter, the control unit 801 controls the operation of the sheet cutting unit 100 such that the relative position of the cutter 3 with respect to the to-be-cut object 11 changes along the third cutting line 17. That is, as illustrated in FIG. 7C, the direction of the blade 300 of the cutter 3 is changed from the +X direction to the direction along the third cutting line 17 inclined by the angle AB with respect to the +X direction at the start of cutting the to-be-cut object 11 along the third cutting line 17. However, when the angle of change in the direction of the blade 300 is small, the amount of deformation of the to-be-cut object 11 that receives an external force from the blade 300 due to rotation of the cutter 3 is small. Therefore, when the angle of change in the direction of the blade 300 is small, even if the direction of the blade 300 of the cutter 3 is changed at the start of cutting of the next cutting line, a portion of the to-be-cut object 11 at the cutting start position is less likely to be scratched.

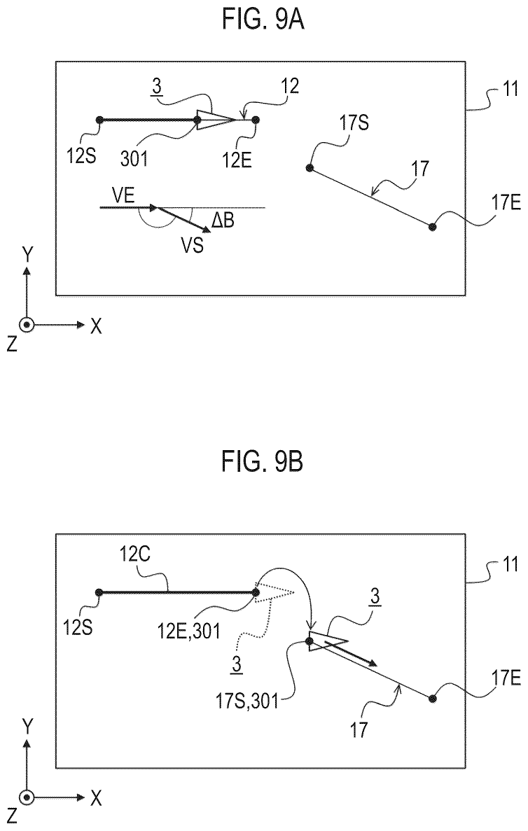

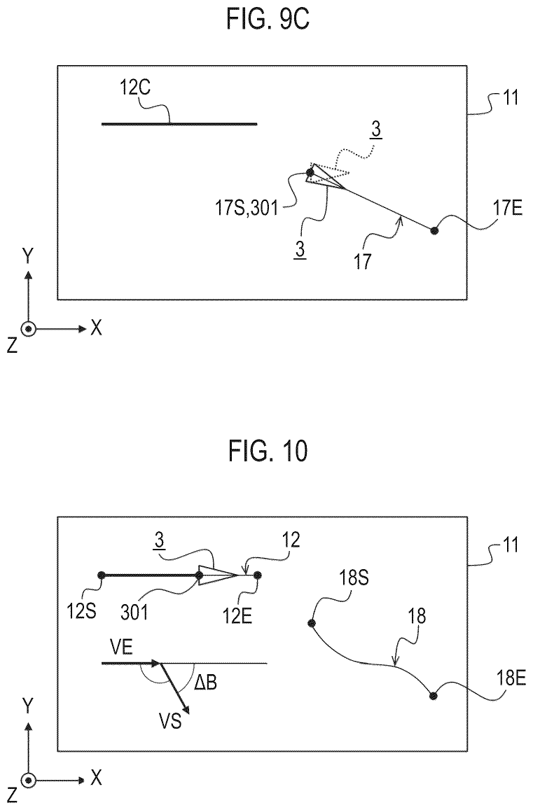

Note that the cutting line set on the to-be-cut object 11 based on the cutting data is not limited to, for example, straight cutting lines (line segments) such as the cutting lines 12, 13, and 17 illustrated in FIG. 4A, FIG. 9A, and the like. The cutting line may be, for example, a curve such as a fourth cutting line 18 set on the to-be-cut object 11 illustrated in FIG. 10. The cutting line set on the to-be-cut object 11 may include a closed curve such as a circle whose cutting end position coincides with the cutting start position. The cutting line may include a straight line or a curve intersecting another cutting line, and a straight line or a curve branched from a position different from a cutting start position and a cutting end position in another cutting line.

Further, in the cutting processing performed by the cutting device 1 according to the present embodiment, for example, one cutting line connecting two points may be divided into a plurality of cutting lines. In other words, one cutting line along which the blade 300 of the cutter 3 can cut without being separating from the to-be-cut object 11 may be divided into a plurality of cutting lines according to predetermined conditions. For example, when there is a break point (corner) between the cutting start position and the cutting end position in one cutting line, the cutting line may be divided at the break point. In a case where it is permitted to divide one cutting line into a plurality of cutting lines in cutting data, for example, processing of determining whether the cutting start position of the cutting line to be cut next is separated from the current relative position (cutting end position) of the cutter 3 may be added between steps S7 and S8 in the flow of FIG. 5 and between steps S7 and S12 in the flow of FIG. 7.

The above-described embodiments are specific examples to facilitate understanding of the invention, and the present invention is not limited to the above-described embodiments. Various modifications and changes of the cutting device, the cutting method, and the recording medium can be made without departing from the scope of the claims.

What is claimed is:

1. A cutting device comprising:
a cutter;
a carriage that holds the cutter such that, when a relative position of the cutter with respect to a to-be-cut object is changed in a state in which a blade of the cutter bites into the held to-be-cut object, a direction of the blade is changed depending on a direction in which the relative position changes;
an actuator that changes the relative position of the cutter held by the carriage with respect to the to-be-cut object in order to cut the to-be-cut object with the blade; and
at least one processor that controls the actuator such that the blade of the cutter moves along a cutting line set on the to-be-cut object, wherein
when a cutting end position of a first cutting line set on the to-be-cut object and a cutting start position of a second cutting line to which the blade moved along the first cutting line is moved next are separated from each other, the at least one processor controls the actuator to perform cutting edge adjustment control of causing a direction of the blade facing a first direction at the cutting end position of the first cutting line to face a second direction for cutting the to-be-cut object from the cutting start position of the second cutting line.

2. The cutting device according to claim 1, wherein
the at least one processor determines whether to perform the cutting edge adjustment control based on the first direction of the blade at the cutting end position of the first cutting line and the second direction of the blade when the to-be-cut object is cut from the cutting start position of the second cutting line.

3. The cutting device according to claim 1, wherein,
when the cutting start position of the second cutting line is separated from the cutting end position of the first cutting line, the first direction and the second direction of the blade are different, and an absolute value of an angle of change of the blade from the first direction to the second direction is equal to or less than a threshold value, the at least one processor:
determines that the cutting edge adjustment control will not be performed, and
separates the blade from the to-be-cut object without changing the direction of the blade to the second direction at the cutting end position of the first cutting line.

4. The cutting device according to claim 2, wherein,
when the cutting start position of the second cutting line is separated from the cutting end position of the first cutting line, the first direction and the second direction of the blade are different, and an absolute value of an angle of change of the blade from the first direction to the second direction is equal to or less than a threshold value, the at least one processor:
determines that the cutting edge adjustment control will not be performed, and
separates the blade from the to-be-cut object without changing the direction of the blade to the second direction at the cutting end position of the first cutting line.

5. A cutting method for controlling an operation of a cutting device including a cutter, an actuator for changing a relative position between the cutter and a held to-be-cut object, and at least one processor, the cutting method comprising:
when a cutting end position of a first cutting line set on the to-be-cut object and a cutting start position of a second cutting line to which the blade moved along the first cutting line is moved next are separated from each other, controlling the actuator to perform cutting edge adjustment control of causing a direction of the blade facing a first direction at the cutting end position of the first cutting line to face a second direction for cutting the to-be-cut object from the cutting start position of the second cutting line.

6. A non-transitory computer-readable recording medium recording a program for controlling an operation of a cutting device including a cutter, an actuator for changing a relative position between the cutter and a held to-be-cut object, and at least one processor, the program causing the at least one processor to execute:
when a cutting end position of a first cutting line set on the to-be-cut object and a cutting start position of a second cutting line to which the blade moved along the first cutting line is moved next are separated from each other, controlling the actuator to perform cutting edge adjustment control of causing a direction of the blade facing a first direction at the cutting end position of the first cutting line to face a second direction for cutting the to-be-cut object from the cutting start position of the second cutting line.
